(19) United States
(12) Patent Application Publication
(10) Pub. No.: US 2004/0048182 A1
(43) Pub. Date: Mar. 11, 2004

(54) Developing agent and method for manufacturing the same

(75) Inventor: Takashi Urabe, Shizuoka-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/235,667

(22) Filed: Sep. 6, 2002

(51) Int. Cl. G03G 9/093

(52) U.S. Cl. 430/110.2; 430/137.11; 430/137.12

(57) ABSTRACT

A multi-layered toner comprises a core and a covering layer. The binder resin in the core has an acid value differing from the acid value of the binder resin in the covering layer.

### BACKGROUND OF THE INVENTION

The present invention relates to a developing agent used in an image forming apparatus of an electrostatic recording system or an electrophotographic system.

In an image forming apparatus of an electrophotographic system, an electrostatic latent image is formed on a photoreceptor, followed by developing the resultant electrostatic latent image with a toner so as to obtain a toner image. Then, the toner image is transferred onto a transfer material such as a paper, followed by fixing the toner image to the transfer material by, for example, applying pressure to the toner image under heat. The contact bonding system under heat, which uses a heat roller, is the method that is most popularly employed nowadays in the fixing process.

In the heat roller system, an unfixed toner image is transferred along the surface of the heat roller in contact with the surface of the heat roller, the surface of the heat roller being formed of a material having a releasability relative to the toner, while applying pressure to the toner image so as to fix the toner image. In the heat roller system, it is necessary to maintain the set temperature of the heat roller falling within an appropriate temperature range in order to prevent defective fixation resulting from a change in temperature of the heat roller caused by the passage of the toner and the transfer material, or another external factor, and to prevent the offset phenomenon that the toner is transferred onto the heat roller. Therefore, it is necessary to increase the heat capacity of the heat roller or the heating medium. As a result, more power is required.

In order to overcome the above-noted problem inherent in the fixing system, required is a toner that can be fixed over a wide temperature range. Under the circumstances, various toners have been developed to date, including a toner containing a material that permits improving the releasability, such as polypropylene wax, so as to prevent the offset problem, a toner using a crosslinked resin, and a toner containing a wax that can melt under 90° C., so as to permit the toner to be fixed at a lower temperature.

Also, various copying machines capable of producing various images ranging from a monochromatic image to a full color image have been developed in recent years. The full color image includes a glossy image quality such as a silver salt photo and a gloss-suppressed image, which is widely used in business documents. In order to obtain a glossy image quality, employed is the technology such as the use of a binder resin having sharp melt characteristics, a fine dispersion of a pigment or a wax, or the selection of a binder resin closer to a colorless state.

In order to realize the fixing at a lower temperature, it is known to the art to lower the glass transition temperature and the molecular weight of the binder resin so as to lower the melt viscoelasticity of the toner. However, this method gives rise to the problem that, since the melt viscoelasticity is excessively lowered under high temperatures, the offset region is rendered narrow. It is also known to the art to allow the toner to contain a substance having a high acid value in order to improve the fixing properties by improving the affinity with the paper sheet. However, in the case of using a substance having a high acid value, the agglomeration of the toner particles under an environment of a high temperature and a high humidity, i.e., a so-called “blocking problem”, tends to take place easily. Further, in order to simultaneously satisfy both the fixation at a low temperature and the storage capability, proposed is a toner of a multi-layered structure comprising a core made of a material having a low softening temperature and a covering layer made of a material having a high softening point, as disclosed in, for example, Jpn. Pat. Appln. KOKAI Publication No. 11-174732. However, in the toner proposed in this prior art, the material forming the core is poor in compatibility with the material forming the covering layer, giving rise to the problem that the transparency of the toner tends to be lowered.

### BRIEF SUMMARY OF THE INVENTION

An object of the present invention, which has been achieved in view of the situation described above, is to provide a developing agent satisfactory in any of the charging properties, the fixing properties, and the storage capability.

Another object of the present invention is to provide an image forming apparatus capable of forming a high quality image by using a toner satisfactory in any of the charging properties, the fixing properties and the storage capability.

According to a first aspect of the present invention, there is provided a developing agent having a multi-layered toner particle, comprising a toner core containing a coloring agent and a first binder resin having a first acid value, and a resin covering layer provided on the toner core and containing a second binder resin having a second acid value differing from the first acid value.

According to a second aspect of the present invention, there is provided a method of manufacturing a developing agent, comprising covering the surface of a toner core containing a coloring agent and a first binder resin having a first acid value a resin covering material containing a second binder resin having a second acid value differing from the first acid value so as to form a resin covering layer, thereby obtaining a multi-layered toner particle.

Further, according to a third aspect of the present invention, there is provided an image forming apparatus, comprising:

at least one image carrier;

a developing mechanism equipped with a developing device arranged to face the image carrier for developing an electrostatic latent image formed on the image carrier so as to form a developing agent image;

a transfer mechanism for transferring the developing agent image onto a transfer material; and

a fixing device for fixing the developing agent image transferred onto the transfer material,

wherein a developing agent having a multi-layered toner particle comprising a toner core containing a coloring agent and a first binder resin having a first acid value, and a resin covering layer covering the toner core and containing a second binder resin having a second acid value differing from the first acid value is housed in the developing device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a model drawing for explaining an example of the construction of a toner of the present invention;

FIG. 2 is a conceptual drawing for explaining the principle of the mechanofusion treatment;

FIG. 3 schematically shows an example of the construction of an apparatus used for the hybridization treatment;

FIG. 4 schematically shows the construction of a surfusing system;

FIG. 5 is a flow chart showing an example of a manufacturing method of a toner of the present invention;

FIG. 6 is a flow chart showing another example of a manufacturing method of a toner of the present invention; and

FIG. 7 exemplifies the construction of the image forming apparatus preferably used in the present invention.

### DETAILED DESCRIPTION OF THE INVENTION

The developing agent of the present invention has a multi-layered toner particle comprising a toner core and a resin covering layer provided on the surface of the toner core. The toner core contains a coloring agent and a first binder resin having a first acid value. On the other hand, the resin covering layer contains a second binder having a second acid value differing from the first acid value.

The toner particle contained in the developing agent of the present invention has a multi-layered structure. Since one of the binder resins differing from each other in the acid value is applied to the toner core and the other binder resin is applied to the resin covering layer, it is possible to achieve separation of the function by adjusting the acid value between the toner core and the resin covering layer.

As an example of the separation of the function, it is possible to make, for example, the first acid value higher than the second acid value. In this case, a binder resin having a high acid value, which is effective for obtaining satisfactory fixing properties, is used for forming the toner core, and a binder resin having a low acid value, which is effective for obtaining a good storage capability under high temperatures and for obtaining a high resistance to the stress, is used for forming the resin covering layer By such a separation of the function, it is possible to simultaneously satisfy the fixing properties, the charging properties, the resistance to the stress and storage capability under high temperatures.

Also, it is preferable for the first acid value to be higher than the second acid value, for the first acid value to be at least 10, and for the second acid value to be not higher than 10. If the first acid value is lower than 10, the fixing performance of the developing agent tends to be lowered. On the other hand, if the second acid value exceeds 10, the change in the charging properties depending on the environment tends to be increased.

Incidentally, in the present invention, it suffices for the first and second binder resins to be different from each other in the acid value. In other words, the present invention covers the case where the binder resin may have an acid value of zero.

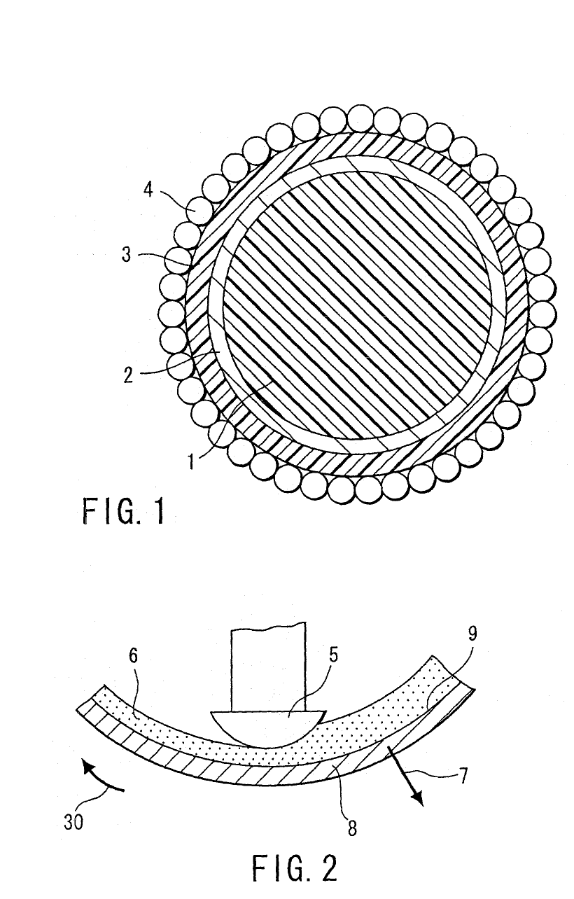

FIG. 1 is a model drawing for explaining as an example the construction of the toner of the present invention. As shown in the drawing, the toner comprises a multi-layered toner particle including a toner core body 1 containing mainly a first binder resin having a first acid value, a coloring agent layer 2 formed on the surface of the toner core body 1, and a resin covering layer 3 covering the outer surface of the coloring agent layer 2 and containing mainly a second binder resin having a second acid value differing from the first acid value. The toner also comprises additive particles 4 optionally attached to the surface of the multi-layered toner particle, i.e., to the surface of the resin covering layer 3.

As described above, the toner core body 1 contains a coloring agent and a first binder resin. It is possible for the coloring agent to be dispersed within the toner core body 1. Alternatively, it is also possible for the coloring agent to be attached to or to cover the surface of the toner core body 1 containing the first binder resin as a main component.

It is possible to add a wax, a charge control agent and other additives to the toner core body 1. The other additives noted above include, for example, a lubricant, a cleaning aid and a fluidizing agent.

The additive particle 4 includes, for example, a silica particle, a titania particle, an alumina particle, a metallic soap, and a resin fine particle.

The toner core body can be formed by, for example, a polymerization method or a pulverizing method.

As described above, the resin covering layer contains at least the second binder resin. It is possible to add, for example, a wax, a coloring agent, a lubricant, a cleaning aid, and a fluidizing agent, as required, to the resin covering layer.

It is more preferable to add a wax to the toner core body alone, compared with the wax addition to the resin covering layer. In the case of adding the wax to the toner core body alone, the resistance of the developing agent to the stress is further improved.

It is possible for the second binder resin contained in the resin covering layer and the first binder resin contained in the toner core body to be equal to or different from each other in the main constituting portion of the repeating unit of the polymer, though it is preferable to select resins compatible with each other in order to obtain a sufficient mechanical strength required for the toner.

It is possible for the present invention to provide a color developing agent, e.g., yellow, cyan and magenta developing agents for forming a full color image. In this case, it is preferable for the difference between the first acid value and the second acid value to be not larger than 20. Where the difference noted above is not larger than 20, it is possible to further improve the compatibility between the first binder resin and the second binder resin and to ensure a sufficient transparency required for the developing agent.

In the case of the color developing agent, it is preferable for the first binder resin to have a glass transition point falling within a range of between 15° C. and 80° C., and for the second binder resin to have a glass transition point falling within a range of between 45° C. and 130° C. It is more preferable for the glass transition point of the first binder resin to be higher than the glass transition point of the second binder resin.

In this case, it is possible to realize both the fixing capability under low temperatures and the storage capability while maintaining the compatibility between the first and second binder resins and the transparency of the developing agent.

In the case of adding a wax to the binder resin, it is preferable for the difference between the acid value of the wax and the acid value of the binder resin to be not larger than 10. In this case, it is possible to obtain a good transparency. Also, in order to achieve the fixing under low temperatures, it is preferable to use a wax having a melting point falling within a range of between 40° C. and 90° C.

The resin covering layer can be formed by one of the polymerization method and the dry process.

In the case of employing the polymerization method, the resin covering layer can be formed by the polymerization achieved on the surface of the toner core body among the raw materials of the second binder resin, e.g., an optional material selected from the group consisting of the monomer, oligomer, low molecular weight polymer and preliminary polymer of the second binder resin.

On the other hand, the dry process employed in the present invention is a process for covering the surface of the toner core body with a material containing a resin as a main component and a process other than the polymerization carried out under the liquid state such as the solution polymerization, the suspension polymerization and the emulsion polymerization.

The dry process employed in the present invention includes, for example, a mechanical process, a thermal process, a mechanochemical process and a process based on combination of at least two of these processes.

The polymerization carried out under the liquid state such as the solution polymerization, the suspension polymerization or the emulsion polymerization requires a costly process. On the other hand, in the case of employing a dry process such as the mechanical, thermal or mechanochemical process for forming the resin covering layer, the toner having a multi-layered structure can be formed easily at a low cost. It is also possible to apply easily an additive such as a charge control agent to the resin covering layer.

The resin covering layer can be formed by a single dry process using a single resin covering material. It is also possible to form the resin covering layer by employing a plurality of dry processes in combination by using a single resin covering material and by changing the kind, the conditions, etc. of the dry processes. Alternatively, it is possible for the resin covering layer to cover an optional resin covering material by a plurality of dry processes using a plurality of resin covering materials. As a result, at least two resin covering layers can be obtained. Further, the additives that can be applied to the surface of the toner particle such as the cleaning aid and the fluidizing agent can be applied easily to the resin covering layer after the dry process.

In the case of forming, for example, three resin covering layers including a first resin covering layer formed on the surface of the toner core, a second resin covering layer formed on the first resin covering layer, and a third resin covering layer forming the outermost resin covering layer, it is possible to employ the combinations of the polyester resin layer-styrene acrylic resin layer-styrene acrylic resin layer, the polyester resin layer-polyester resin layer-styrene acrylic resin layer, and the styrene acrylic resin layer-polyester resin layer-styrene acrylic resin layer. Particularly, it is preferable to employ the combination of the polyester resin layer-polyester resin layer-styrene acrylic resin layer in view of the good balance between the fixing properties under low temperatures and the cost.

Incidentally, powdery resin materials such as the resin single body particles, the resin composition particles and the particles having the toner composition can be suitably used in the dry process as the resin covering material.

A typical dry process employed in the present invention includes, for example, a mechanofusion treatment, a hybridization treatment, and a surfusing treatment.

FIG. 2 is a conceptual drawing for explaining the principle of the mechanofusion treatment. The mechanofusion treatment is one of the mechanical processes. In the mechanofusion treatment, an ordered mixture in which child particles are attached to a mother particle, which is prepared by, for example, the dry mixing of a powdery material containing the mother particles and the child particles, is put as a powdery raw material 6 into a rotary container 8 rotated in the direction denoted by, for example, an arrow 30. As a result, the powdery raw material 6 is pushed against the inner wall 9 of the rotary container 8 by the centrifugal force exerted in the direction denoted by an arrow 7. In addition, an inner piece 5 differing from the inner wall 9 in the radius of curvature is applied to the fixed powdery raw material 6 so as to impart a stronger compression force and shearing force to the powdery raw material 6, thereby preparing composite particles, controlling the shape of the particle and achieving a precision mixing.

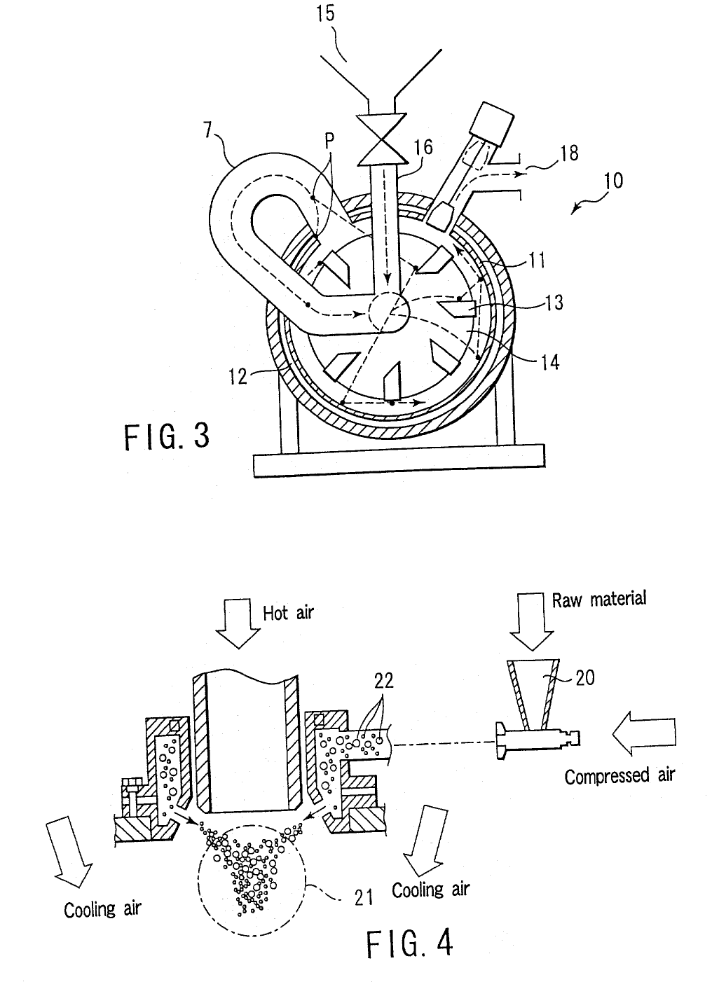

FIG. 3 schematically shows an example of the construction of an apparatus used for the hybridization treatment.

The hybridization treatment is one of the mechanical and thermal processes. An apparatus 10 shown in FIG. 3 is used for the hybridization treatment. As shown in the drawing, the apparatus 10 comprises a cylindrical stator 11 equipped with a jacket 12 for water-cooling and for heating, a rotor 14 arranged within the stator 11, equipped with a plurality of blades 13 and capable of rotation at a high speed, an inlet port 15 for introducing a powdery material into the stator 11, an introducing passageway 16 connected to the inlet port 15 for introducing the powdery material into the central portion of the rotor 14, a circulating passageway 17 for transferring again the powdery material from the inner wall of the stator to the central portion of the rotor 14, and a discharge port 18 for discharging the processed powdery material.

In the apparatus 10 shown in FIG. 3, a powdery raw material, e.g., an ordered mixture, is put into the inlet port 15 so as to be dispersed within the rotor 14 rotated at a high speed and to the inner wall of the stator 11. Further, the raw material powder is circulated again through the circulating passageway 17 from the inner wall of the stator 11 to the central portion of the rotor 14. As a result, a mechanical function including the interaction of the particles consisting essentially of the impact force such as the compression, friction and shearing force is repeatedly applied to the powdery material so as to permit the child particles to fix the mother particles, to form a film and to make the particles spherical. The processed powdery material can be promptly recovered in a collector (not shown) through the discharge port 18. Incidentally, “P” in FIG. 3 denotes the powdery material, and the arrows denoted by dotted lines represent the behavior of the powdery material P.

FIG. 4 schematically shows the construction of a surfusing system. The surfusing system is one of the thermal processes. In the surfusing system, a powdery raw material 22, e.g., an ordered mixture, put into an inlet port 20 is supplied into a process section 21 and dispersed by a hot air stream within the process section 21 by a special method using compressed air, as shown in the drawing. As a result, the powdery raw material 22 is heated to a temperature not lower than the temperature at which the powdery raw material 22 melts, thereby making the particles of the powdery material spherical, and allowing the child particles to be fixed to the mother particles. Alternatively, where the child particles are formed of resin fine particles, the child particles can be formed into a film on the surface of the mother particle.

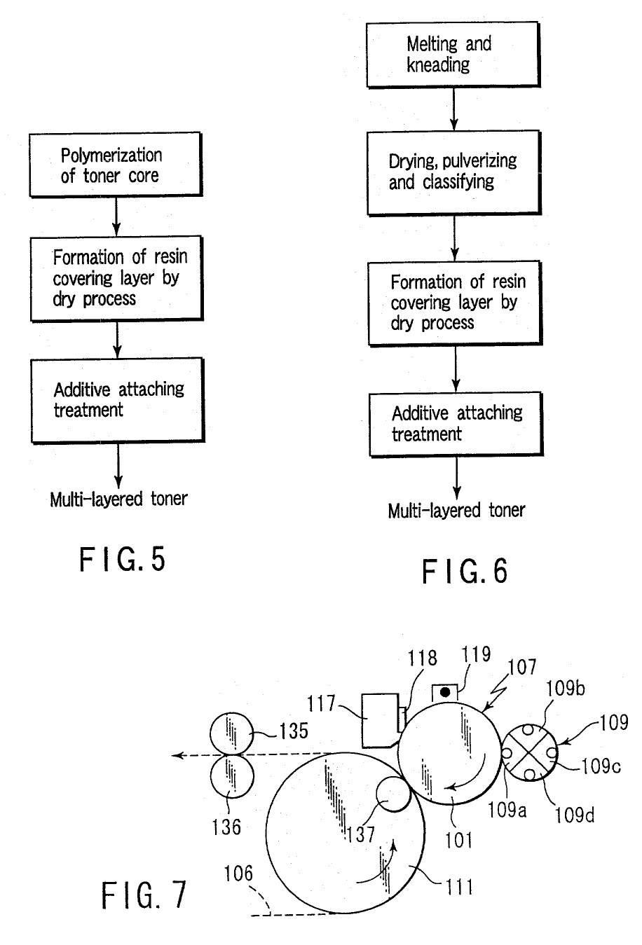

FIGS. 5 and 6 are flow charts each showing the manufacturing process of a multi-layered toner, covering the case where the resin covering layer is formed by the dry process.

FIG. 5 covers the case where the toner core is manufactured by the polymerization method. In this case, the method of manufacturing the developing agent comprises the process of polymerizing a toner core polymerizing material containing a coloring agent and including a monomer and a performed polymer of the binder resin so as to obtain a toner core, the process of forming by a dry process a resin covering layer on the surface of the toner core thus obtained so as to obtain multi-layered toner particles, the process of attaching an additive to the multi-layered toner particles thus obtained.

It is possible to modify the manufacturing method of the developing agent described above. The modified manufacturing method comprises the process of polymerizing a polymerizable material of the toner core that does not contain a coloring agent so as to obtain a toner core body, the process of attaching a coloring agent to the surface of the toner core body so as to form a toner core, the process of forming a resin covering layer on the surface of the toner core thus obtained by a polymerization method or a dry process so as to obtain multi-layered toner particles, and the process of optionally attaching an additive to the multi-layered toner particles.

The toner cores obtained by the polymerization method are relatively low in the nonuniformity of the particle diameter. In other words, the polymerization method permits obtaining toner particles uniform in the particle diameter and in the shape of the particle.

FIG. 6 covers the case where the toner core is formed by a pulverizing method. In this case, the method of manufacturing the developing agent comprises the process of melting and kneading a toner core material containing a coloring agent and including, for example, a binder resin, the process of forming a resin covering layer on the surface of the resultant toner core by, for example, a dry process so as to obtain multi-layered toner particles, and the process of optionally attaching an additive to the multi-layered toner particles.

It is also possible to modify the manufacturing method described above. The modified method of manufacturing the developing agent comprises the process of melting and kneading a toner core material that does not contain a coloring agent, the process of drying, pulverizing and classifying the resultant kneaded mixture so as to form a toner core body, the process of attaching a coloring agent to the surface of the resultant toner core body so as to form a toner core, the process of forming a resin covering layer by a dry process on the resultant toner core so as to obtain multi-layered toner particles, and the process of optionally attaching an additive to the multi-layered toner particles.

The toner cores obtained by the pulverizing method are somewhat nonuniform in the particle diameter, and the shapes of the toner cores are irregular. However, an impact is imparted to the toner cores by the dry process in the step of forming the resin covering layer, with the result that it is possible for the toner cores to be rendered spherical. It is also possible for the toner somewhat irregular in the shape of the toner particles to produce an effect superior to that produced by the toner consisting of uniform spherical toner particles uniform in the particle diameter in an image forming apparatus equipped with a cleaning device including, for example, cleaning blades. To be more specific, it is possible to expect an effect that the passage of the toner through the cleaning blades is obstructed so as to improve the cleaning performance.

Incidentally, the process of attaching an additive is an optional process and, thus, can be omitted. Also, in the manufacturing method described above, the resin covering layer is formed by a dry process. However, it is possible to employ the polymerization method in place of the dry process, though it is more advantageous in terms of the manufacturing cost to employ the dry process than to employ the polymerization method in forming the resin covering layer on the toner core.

The image forming apparatus to which the developing agent of the present invention can be applied comprises:

at least one image carrier;

a developing mechanism equipped with a developing device arranged to face the image carrier for developing an electrostatic latent image formed on the image carrier to form a developing agent image;

a transfer mechanism for transferring the developing agent image onto a transfer material; and

a fixing device for fixing the developing agent image transferred onto the transfer material,

wherein a developing agent having a multi-layered toner particle comprising a toner core containing a coloring agent and a first binder resin having a first acid value, and a resin covering layer covering the toner core and containing a second binder resin having a second acid value differing from the first acid value is housed in the developing device.

FIG. 7 exemplifies the construction of an image forming apparatus that is preferably used in the present invention. As shown in the drawing, the image forming apparatus comprises a photoreceptor drum 101 acting as an image carrier. The photoreceptor drum 101 is formed of a cylindrical multi-layered type organic photoreceptor having a diameter of 40 mm and a length of 266 mm and is arranged rotatable in the direction denoted by an arrow.

Various devices are arranged along the photoreceptor drum 101 in the rotating direction of the photoreceptor drum 101. Specifically, a developing device 109 housing a developing agent is arranged to face the photoreceptor drum 101 so as to develop an electrostatic latent image formed on the photoreceptor drum 101 in an exposure section 107. A transfer means 111 for transferring a recording material of a paper sheet onto which the developing agent image is transferred, which is shaped like, for example, a roller, is arranged downstream of the developing device 109 in the rotating direction of the photoreceptor drum 101 in a manner to face the photoreceptor drum 101. The transfer means 111 is arranged to be capable of rotation in synchronism with the rotation of the photoreceptor drum 101. A blade cleaning device 117 equipped with a cleaning blade 118 and a destaticizing lamp 119 are arranged downstream of the transfer means 111 in the rotating direction of the photoreceptor drum 101. The cleaning blade 118 of the blade cleaning device 117 serves to scrape off the developing agent remaining on the photoreceptor drum 101 after transfer of the developing agent image onto the recording material. Also, the destaticizing lamp 119 is formed of a tungsten lamp serving to destaticize the surface of the photoreceptor drum 101 by means of light irradiation. One cycle of the image forming process is finished by the destaticization achieved by the destaticizing lamp 119. Then, the uncharged photoreceptor drum 101 is charged again in forming the next image on the photoreceptor drum 101.

A paper feeding cassette (not shown) housing paper sheets is arranged in the vicinity of the transfer means 111. A paper sheet is transferred from the paper feeding cassette in the direction denoted by an arrow 106 so as to be fed into the clearance between the photoreceptor drum 101 and the transfer means 111.

As shown in the drawing, the developing device 109 is partitioned into four sections so as to provide a first developing section 109a, a second developing section 109b, a third developing section 109c and a fourth developing section 109d. The developing device 109 is arranged rotatable such that the first developing section 109a, the second developing section 109b, the third developing section 109c and the fourth developing section 109d are successively positioned to face the photoreceptor drum 101. The developing agents of the present invention differing from each other in color are housed in these four developing sections. For example, a yellow developing agent is housed in the first developing section 109a, a magenta developing agent is housed in the second developing section 109b, a cyan developing agent is housed in the third developing section 109c, and a black developing agent is housed in the fourth developing section 109d.

In the image forming apparatus of the construction described above, an image formation is carried out as follows.

In the first step, a bias voltage is applied by a charging means (not shown) to the photoreceptor drum 101 so as to uniformly charge the photoreceptor drum 101. Then, a first electrostatic latent image is formed on the photoreceptor drum 101 by the light irradiation 107. Further, the first developing section 109a of the developing device 109 is positioned to face the first electrostatic latent image formed on the photoreceptor drum 101. As a result, the first developing agent is supplied onto the photoreceptor drum 101 so as to form a first developing agent image.

When a paper sheet is transferred to the transfer position, a bias voltage is applied by a power supply means 137 to the transfer means 111. By the application of the bias voltage, an electric field for transferring the developing agent image is formed between the photoreceptor drum 101 and the transfer means 111. As a result, a yellow developing agent image formed on the photoreceptor drum 101 is transferred onto the paper sheet.

Then, the first developing agent and the electric charge remaining on the photoreceptor drum 101 are removed by the cleaning device 117 and the destaticizing means 119, respectively.

After removal of the yellow developing agent and the electric charge from the photoreceptor drum 101, a second electrostatic latent image is formed on the photoreceptor drum 101 by the light irradiation 107. In this step, the developing device 109 is rotated by ¼ of one complete rotation so as to permit the second developing section 109b to be positioned to face the photoreceptor drum 101.

Under the state described above, a magenta developing agent is supplied onto the second electrostatic latent image so as to form a magenta developing agent image. Then, a bias voltage is applied again from the power supply means 137 to the transfer means 111 so as to form an electric field for transferring the developing agent image between the photoreceptor drum 101 and the transfer means 111. As a result, the magenta developing agent image formed on the photoreceptor drum 101 is further transferred onto the paper sheet having the yellow developing agent image formed thereon previously.

By repeating the similar steps for each of the cyan developing agent and the black developing agent, formed on the paper sheet is a laminated layer consisting of the yellow developing agent image, the magenta developing agent image, the cyan developing agent image and the black developing agent image.

A paper sheet P bearing the full color image formed by the multiple transfer of the developing agent images differing from each other in color is transferred in the direction denoted by the arrow 106 into the fixing device including a heating roller 135 and a pressurizing roller 137. Since the paper sheet P is transferred between the heating roller 135 and the pressurizing roller 137 such that the developing agent image formed on the paper sheet P is in contact with the heating roller 135, the developing agent image is fixed to the paper sheet P. The fixed image thus formed was found to be satisfactory.

Incidentally, the apparatus of the construction described above is no more than an example of the image forming apparatus to which the developing agent of the present invention can be applied. In other words, the developing agent of the present invention can also be applied to a full color image forming apparatus and a monochromatic image forming apparatus of another construction.

The binder resin used in the present invention includes, for example, a polyester resin, a polystyrene resin, a styrene-acrylate copolymer resin, a polyester-styrene acrylate hybrid resin, an epoxy resin, and a polyether polyol resin.

The wax used in the present invention includes, for example, a natural wax such as rice wax or carnauba wax, a petroleum wax such as a paraffin wax, and a synthetic wax such as a fatty acid ester, a fatty acid amide, a low molecular weight polyethylene, or a low molecular weight polypropylene.

The coloring agent used in the present invention includes, for example, carbon black and an organic or inorganic pigment and dye. The carbon black used in the present invention, which is not particularly limited, includes, for example, acetylene black, furnace black, thermal black, channel black and Ketchen black.

The pigment and dye used in the present invention includes, for example, pigment yellow 180, fast yellow G, benzidine yellow, Indian fast orange, irrugazine red, carmine FB, carmine 6B, permanent bordeaux FRF, pigment orange R, pigment red 122, lithol red 2G, lake red C, rhodamine FB, rhodamine B lake, phthalocyanine blue, pigment blue 15-3, brilliant green B, phthalocyanine green and quinacridone. These pigments and dyes can be used singly or in the form of a mixture of at least two of these materials.

It is also possible to prepare a developing agent of a two component system by mixing the multi-layered toner particle with a carrier.

### EXAMPLES

The present invention will now be described more in detail with reference to the following Examples of the present invention.

### Example 1

Prepared were the toner core materials given below:

Toner Core Materials

| | |
|---|---|
| First binder resin (polyester resin having acid | 90 parts by weight |
| value of 40) | |
| Pigment (carbon black) | 5 parts by weight |
| Wax (propylene wax) | 4 parts by weight |
| Colored metal complex CCA T-77 (manufactured by | 1 part by weight |
| Hodogaya Kagaku K.K.) | |

The toner core materials given above were dispersed in an air stream type mixer, followed by kneading the dispersed mixture in a biaxial extruder so as to obtain a sheet of the kneaded mixture. Then, the resultant sheet was pulverized by a mechanical pulverizing machine so as to obtain roughly pulverized particles each having a diameter of about 1 mm, followed by finely pulverizing the roughly pulverized particles by an ultrasonic jet pulverizing machine until the finely pulverized particles have an average volume particle diameter of 7 μm and subsequently classifying the finely pulverized particles, thereby obtaining the toner core.

In the next step, prepared as a second binder resin were 15 parts by weight of polyester resin fine particles having an acid value of 5 relative to 85 parts by weight of the toner core obtained as described above. Then, the polyester resin fine particles were applied to a mechanofusion system AMS-1 manufactured by Hosokawa Micron Inc. so as to permit the polyester resin fine particles to be attached to the surface of the toner core by a mechanical impact, thereby obtaining toner of a desired multi-layered structure having layers differing from each other in the acid value.

Further, 0.4 parts by weight of silica were added to and sufficiently mixed with 100 parts by weight of the toner thus obtained by using a Henschel mixer manufactured by Mitsui Kozan K.K. so as to apply a surface treatment to the toner, thereby obtaining a desired toner.

The desired toner thus obtained was set in a copying machine Premarju 455 manufactured by Toshiba Tec. K.K. and modified for evaluation. After the fixing temperature of the copying machine was set at 140° C., a patterned image for testing was formed. A test for the fixation remaining rate was applied to the image thus formed. Also, various tests were applied to the toner thus obtained as follows.

Test for Fixation Remaining Rate

Measured was a ratio of the image concentration before the image was rubbed with a fastness tester to the image concentration after the rubbing. Table 1 shows the results.

If the fixation remaining rate is not lower than 80%, the image has a sufficient strength. If the fixation remaining rate falls within a range of between 70% and 79%, the image has a strength giving rise to no practical problems. However, if the fixation remaining rate is not higher than 69%, the image strength is weak and, thus, the image is defective.

The toner prepared in this Example was found to have a fixation remaining rate of 95% as shown in Table 1, supporting that it was possible to obtain a satisfactory image having a sufficiently high fixation strength.

Test for Storage Under High Temperatures

The toner in an amount of 20 g was left to stand for 8 hours or more under an environment of a high temperature (30° C.) and a high humidity (85%), followed by visually confirming the generation of the blocking. Table 1 shows the results. The mark “◯” in Table 1 denotes that an agglomeration was not formed, and the mark “x” denotes that an agglomeration was generated.

Test for Environmental Change in Charging Properties

Two kinds of developing agent were prepared by mixing the obtained toner and a carrier at a certain mixing ratio, and each of the developing agents was subjected to an aging treatment by leaving the developing agent to stand for at least 8 hours under an environment of a low temperature of 10° C. and a low humidity of 20% and under an environment of a high temperature of 30° C. and a high humidity of 85%.

Then, each of the developing agents was used in a Premarju 455, so as to measure the charging amount after the aging treatment by a suction type blow-off apparatus TB-220 manufactured by Toshiba Chemical K.K. As a result, the average charging amount (L/L)q/m of the developing agent, which had been left to stand under an environment of a low temperature and a low humidity (L/L), was found to be 12.42 (−μC/g), as shown in Table 1. On the other hand, the average charging amount (H/H)q/m of the developing agent, which had been left to stand under an environment of a high temperature and a high humidity (H/H), was found to be 9.70 (−μC/g), as shown in Table 1.

The value of (L/L)/(H/H) was calculated in order to obtain an environmental change rate. If the environmental change rate is lower than 1.3, it is possible to obtain a satisfactory image low in the ground fogging regardless of the environmental atmosphere. If the environmental change rate falls within a range of between 1.3 and 1.5, it is possible to obtain a satisfactory image low in the fogging by controlling the machine, regardless of the environmental atmosphere. Further, if the environmental change rate exceeds 1.5, the image is rendered high in the fogging and, thus, rendered poor even if the machine is controlled.

The environmental change rate for Example 1 was found to be 1.28, as shown in Table 1, supporting that it is possible to obtain a satisfactory image low in the fogging regardless of the environmental atmosphere.

### Examples 2 and 3

A desired toner for an electrophotography was prepared under the conditions equal to those for Example 1, except that the acid value of the first binder resin was changed as shown in Table 1, and various tests were applied to the toner as in Example 1. Table 1 also shows the results.

### Examples 4 and 5

A desired toner for an electrophotography was prepared under the conditions equal to those for Example 3, except that the acid value of the second binder resin was changed as shown in Table 1, and various tests were applied to the toner as in Example 1. Table 1 also shows the results.

### Examples 6 and 7

A desired toner for an electrophotography was prepared under the conditions equal to those for Example 1, except that the acid value of the first binder resin was changed as shown in Table 1, and various tests were applied to the toner as in Example 1. Table 1 also shows the results.

### Examples 8 and 9

A desired toner for an electrophotography was prepared under the conditions equal to those for Example 3, except that the acid value of the second binder resin was changed as shown in Table 1, and various tests were applied to the toner as in Example 1. Table 1 also shows the results.

### Example 10

A desired toner for an electrophotography was prepared under the conditions equal to those for Example 1, except that the acid value of the resin positioned in the center was changed to 0, and that the acid value of the resin positioned on the surface was changed to 20, and various tests were applied to the toner as in Example 1. Table 1 also shows the results.

TABLE 1

| | | First | Second | Fixation | Resistance | | | |
|---|---|---|---|---|---|---|---|---|
| | | acid | acid | remaining | to | q/m | q/m | Environmental |
| | | value | value | rate [%] | blocking | (L/L) | (H/H) | change rate |
| Examples | 1 | 40 | 5 | 95 | ∘ | 12.42 | 9.7 | 1.28 |
| | 2 | 25 | 5 | 84 | ∘ | 12.40 | 9.84 | 1.26 |
| | 3 | 10 | 5 | 74 | ∘ | 12.28 | 9.82 | 1.25 |
| | 4 | 10 | 0 | 72 | ∘ | 10.43 | 9.15 | 1.14 |
| | 5 | 10 | 10 | 78 | ∘ | 12.83 | 8.79 | 1.46 |
| | 6 | 9 | 5 | 65 | ∘ | 12.29 | 10.07 | 1.22 |
| | 7 | 0 | 5 | 54 | ∘ | 15.51 | 13.03 | 1.19 |
| | 8 | 10 | 11 | 82 | x | 11.40 | 7.50 | 1.52 |
| | 9 | 10 | 20 | 86 | x | 13.37 | 7.68 | 1.74 |
| | 10 | 0 | 20 | 59 | x | 13.02 | 7.75 | 1.68 |

As apparent from Examples 2 and 3 given in Table 1, a satisfactory image can be obtained in the case where the resin in the toner core has an acid value not smaller than 10. It should be noted in this connection that the resin in the toner core has an acid value of 9 or less in each of Examples 6 and 7. In this case, the image strength was found to be somewhat lowered, as apparent from Table 1.

In each of Examples 4 and 5 in which the resin in the toner core of the toner had an acid value not larger than 10, it was possible to obtain a satisfactory image low in the fogging. On the other hand, in the case of each of Examples 8 and 9 in which was used a toner having a covering resin having an acid value not lower than 11, the formed image was found to be somewhat high in the fogging.

Further, the image formed in Example 10 was found to be somewhat low in the strength of the image, and the fogging was somewhat observed.

### Example 11

Prepared were the toner core materials given below:

Toner Core Materials

| | |
|---|---|
| First binder resin (polyester resin having acid | 90 parts by weight |
| value of 30) | |
| Pigment (phthalocyanine series cyan pigment) | 5 parts by weight |
| Wax (propylene wax) | 4 parts by weight |
| CCA (colorless metal complex) | 1 part by weight |

A toner core was obtained as in Example 1 by using the toner core materials given above.

Prepared were 15 parts by weight of polyester resin fine particles having an acid value 20 as the second binder resin relative to 85 parts by weight of the toner core thus obtained. Then, a colored toner of a desired multi-layered structure having layers differing from each other in the acid value was obtained as in Example 1.

A mixture consisting of 100 parts by weight of the colored toner thus obtained and 0.4 part by weight of silica was applied to a Henschel mixture manufactured by Mitsui Kozan K.K. so as to apply a surface treatment to the toner, thereby obtaining a desired colored toner.

The test for the fixation remaining rate, the test for the storage under high temperatures, and the test for the environmental change in the charging properties were applied to the colored toner thus obtained as in Example 1. Table 2 shows the experimental data. Further, an OHP transmitting test was applied to the colored toner, as follows.

OHP Transmitting Test

A patterned image for the testing was formed by using an OHP. Then, the transmission at 500 nm was measured by using U-3200 (trade name of a spectrophotometer manufactured by Hitachi Ltd.).

Where the OHP transmission is not lower than 80%, the image has a sufficient transmission. Where the OHP transmission falls within a range of between 70% and 79%, the image gives rise to no practical problem in terms of the transmission. Further, where the OHP transmission is not higher than 69%, the image is poor in the color reproducibility.

Table 2 also shows the experimental data. As shown in Table 2, the OHP transmission for Example 11 was found to be 92%, supporting that the formed image exhibited a sufficient transmission.

Also, the fixation remaining rate was found to be 85%. Further, an agglomerated lump was not confirmed as a result of the storage test under high temperatures, as shown in Table 2.

### Examples 12 to 26

A desired colored toner for an electrophotography was prepared under the conditions equal to those for Example 1, except that the acid value of the first binder resin, the acid value of the second resin, and the glass transition temperature for each of the binder resins were changed as shown in Table 2, and the various tests were applied to the colored toners thus obtained as in Example 11. Table 2 also shows the results.

TABLE 2

| | | | | | | | | | | | Environ- |
|---|---|---|---|---|---|---|---|---|---|---|---|
| | | First | Second | First | Second | OHP | Fixation | Resistance | | | mental |
| | | acid | acid | resin | resin | transmis- | remaining | to | q/m | q/m | change |
| | | value | value | Tg | Tg | sion | rate | blocking | (L/L) | (H/H) | rate |
| Examples | 11 | 30 | 20 | 40 | 80 | 92 | 85 | ∘ | 13.38 | 7.69 | 1.74 |
| | 12 | 30 | 10 | 40 | 80 | 75 | 83 | ∘ | 12.98 | 9.61 | 1.35 |
| | 13 | 40 | 20 | 40 | 80 | 77 | 92 | ∘ | 13.64 | 7.66 | 1.78 |
| | 14 | 20 | 20 | 40 | 80 | 98 | 74 | ∘ | 13.09 | 7.89 | 1.66 |
| | 15 | 30 | 20 | 15 | 80 | 88 | 79 | ∘ | 13.17 | 7.66 | 1.72 |
| | 16 | 30 | 20 | 80 | 80 | 91 | 72 | ∘ | 13.33 | 7.66 | 1.74 |
| | 17 | 30 | 20 | 40 | 45 | 96 | 91 | ∘ | 13.27 | 7.90 | 1.68 |
| | 18 | 30 | 20 | 40 | 30 | 73 | 72 | ∘ | 13.26 | 7.85 | 1.69 |
| | 20 | 30 | 9 | 40 | 80 | 64 | 81 | ∘ | 12.91 | 10.01 | 1.29 |
| | 21 | 30 | 5 | 40 | 80 | 55 | 74 | ∘ | 12.65 | 9.96 | 1.27 |
| | 22 | 30 | 21 | 40 | 80 | 95 | 88 | x | 14.01 | 7.78 | 1.80 |
| | 23 | 30 | 29 | 40 | 80 | 96 | 93 | x | 14.44 | 7.64 | 1.89 |
| | 24 | 30 | 20 | 14 | 80 | 93 | 98 | x | 13.42 | 7.58 | 1.77 |
| | 25 | 30 | 20 | 81 | 80 | 89 | 62 | ∘ | 13.27 | 7.81 | 1.70 |
| | 26 | 30 | 20 | 40 | 44 | 90 | 97 | x | 13.61 | 7.78 | 1.75 |
| | 27 | 30 | 20 | 40 | 131 | 64 | 68 | ∘ | 13.72 | 7.80 | 1.76 |

As apparent from Examples 11 to 14 and 19 to 22 shown in Table 2, a sufficient OHP transmission can be obtained in the case where the difference in the acid value between the resin of the toner core and the coated resin is not larger than 20. However, the OHP transmission is rendered somewhat inferior in the case where the difference in the acid value noted above exceeds 20.

Table 2 also shows that a good resistance to the blocking can be obtained in the case where the acid value of the coated resin is not larger than 20. However, the resistance to the blocking is rendered poor in the case where the acid value of the coated resin exceeds 20.

It has also been found from the comparison among Examples 11, 15, 16, 23 and 24 that, in order to satisfy both a good fixing performance and a good resistance to the blocking, it is preferable for the matrix resin to exhibit a glass transition temperature falling within a range of between 15° C. and 80° C.

Further, it has been found from the comparison among Examples 11, 17, 18, 25 and 26 that, in order to satisfy both a good fixing performance and a good resistance to the blocking, it is preferable for the coated resin to exhibit a glass transition temperature falling within a range of between 45° C. and 130° C.

As described above, Examples 11 to 26 given in Table 2 support that it is possible to obtain a colored toner for an electrophotography high in transparency, satisfactory in the resistance to the blocking, and capable of fixation under low temperatures by defining the acid value of the matrix resin, the acid value of the coated resin, the glass transition temperature of the matrix resin, and the glass transition temperature of the coated resin.

### Example 27

Prepared were the toner core materials given below:

Toner Core Materials

| | |
|---|---|
| First binder resin (styrene acrylic resin having | 90 parts by weight |
| acid value of 30) | |
| Pigment (copper phthalocyanine series cyan | 5 parts by weight |
| pigment) | |
| Wax (propylene wax) | 4 parts by weight |
| CCA (colorless metal complex) | 1 part by weight |

A toner core was obtained as in Example 1 by using the toner core materials given above.

Prepared were 15 parts by weight of polyester resin fine particles having an acid value 20 as the second binder resin relative to 85 parts by weight of the toner core thus obtained. Then, a colored toner of a desired multi-layered structure having layers differing from each other in the acid value was obtained as in Example 1.

A mixture consisting of 100 parts by weight of the colored toner thus obtained and 0.4 part by weight of silica was applied to a Henschel mixture manufactured by Mitsui Kozan K.K. so as to apply a surface treatment to the toner, thereby obtaining a desired colored toner.

The test for the fixation remaining rate, the test for the storage under high temperatures, and the test for the environmental change in the charging properties were applied to the colored toner thus obtained as in Example 1. Further, an OHP transmitting test was applied to the colored toner.

Table 3 shows the experimental data.

### Example 28

Prepared was 85 parts by weight of the toner core similar to that in Example 13, followed by applying polyester resin fine particles having an acid value of 30 as the second binder. Further, a treatment by a dry process was applied to these materials by using a mechanofusion system AMS-1.

Then, a treatment by a dry process was performed by using a mechanofusion system AMS-1 by applying polyester resin fine particles having an acid value of 20 as a third binder resin.

Further, a treatment by a dry process was performed by using a mechanofusion system AMS-1 by applying polyester resin fine particles having an acid value of 0 as a fourth binder resin.

A mixture consisting of 100 parts by weight of the colored toner thus obtained and 1.0 part by weight of silica was applied to a Henschel mixture manufactured by Mitsui Kozan K.K. so as to apply a surface treatment to the toner, thereby obtaining a desired colored toner.

The test for the fixation remaining rate, the test for the storage under high temperatures, and the test for the environmental change in the charging properties were applied to the colored toner thus obtained as in Example 1. Further, an OHP transmitting test was applied to the colored toner.

Table 3 also shows the experimental data.

### Comparative Examples 1 and 2

Toners were obtained as in Examples 5 and 14, respectively, except that the binder resins used had the same acid value.

The test for the fixation remaining rate, the test for the storage under high temperatures, and the test for the environmental change in the charging properties were applied to each of the colored toners thus obtained as in Example 1. Further, an OHP transmitting test was applied to each of the colored toners.

TABLE 3

| | | First | Second | Third | Fourth | First | Second | Third | Fourth | OHP | Fixation | | | | |
|---|---|---|---|---|---|---|---|---|---|---|---|---|---|---|---|
| | | acid | acid | acid | acid | resin | resin | resin | resin | trans- | remaining | Resistance | q/m | q/m | Environmental |
| | | value | value | value | value | Tg | Tg | Tg | Tg | mission | rate | to blocking | (L/L) | (H/H) | change rate |
| Examples | 27 | 30 | 20 | — | — | 80 | 90 | — | — | 90 | 89 | ∘ | 13.91 | 7.73 | 1.80 |
| | 28 | 40 | 30 | 20 | 0 | 40 | 92 | 40 | 80 | 92 | 94 | ∘ | 10.41 | 8.40 | 1.24 |

As apparent from Table 3, each of the OHP transmission, the fixing performance and the resistance to the blocking was satisfactory even if resins differing from each other were used as the first resin and the second resin as in, for example, Example 27.

Also, a good resistance to the blocking can be obtained by controlling the resin and the glass transition point Tg for each layer, as apparent from Example 28. It has also been found that the OHP transmission, the fixing performance and the environmental change rate can be controlled at desired values.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent having a multi-layered toner particle, comprising a toner core containing a coloring agent and a first binder resin having a first acid value, and a resin covering layer provided on the toner core and containing a second binder resin having a second acid value differing from the first acid value.

2. The developing agent according to claim 1, wherein the first acid value is not smaller than 10.

3. The developing agent according to claim 1, wherein the second acid value is not larger than 10.

4. The developing agent according to claim 1, wherein the toner core further contains a wax.

5. The developing agent according to claim 1, wherein the toner core is formed by one method selected from the group consisting of a polymerization method and a pulverizing method.

6. The developing agent according to claim 1, wherein the resin covering layer further contains a wax.

7. The developing agent according to claim 1, wherein the resin covering layer further contains a coloring agent.

8. The developing agent according to claim 1, wherein the resin covering layer includes a plurality of layers formed by successively covering the toner core with two or more resin coating materials.

9. The developing agent according to claim 1, wherein the resin covering layer includes at least three layers.

10. The developing agent according to claim 1, wherein the resin covering layer is formed by one method selected from the group consisting of a polymerization method and a dry process.

11. The developing agent according to claim 10, wherein the dry process is selected from the group consisting of a mechanical process, a thermal process, a mechanochemical process, and a composite process involving at least two of these processes.

12. The developing agent according to claim 1, wherein the dry process is selected from the group consisting of a mechanofusion process, a hybridization process and a surfusing process.

13. The developing agent according to claim 1, wherein the coloring agent is attached to the surface of a core body containing mainly a binder resin.

14. The developing agent according to claim 1, wherein the coloring agent is dispersed within the toner core.

15. The developing agent according to claim 1, wherein the difference between the first acid value and the second acid value is not larger than 20.

16. The developing agent according to claim 1, wherein the second acid value is not larger than 20.

17. The developing agent according to claim 1, wherein the first binder resin has a glass transition point falling within a range of between 15° C. and 80° C., the second binder resin has a glass transition point falling within a range of 45° C. and 130° C., and the glass transition point of the first binder resin is higher than the glass transition point of the second binder resin.

18. A method of manufacturing a developing agent, comprising covering the surface of a toner core containing a coloring agent and a first binder resin having a first acid value with a resin covering material containing a second binder resin having a second acid value differing from the first acid value to form a resin covering layer, thereby obtaining a multi-layered toner particle.

19. An image forming apparatus, comprising:
at least one image carrier;
a developing mechanism equipped with a developing device arranged to face the image carrier for developing an electrostatic latent image formed on the image carrier to form a developing agent image;
a transfer mechanism for transferring the developing agent image onto a transfer material; and
a fixing device for fixing the developing agent image transferred onto the transfer material,
wherein a developing agent having a multi-layered toner particle comprising a toner core containing a coloring agent and a first binder resin having a first acid value, and a resin covering layer provided on the toner core and containing a second binder resin having a second acid value differing from the first acid value is housed in the developing device.
